(19) United States
(12) Patent Application Publication
(10) Pub. No.: US 2012/0113367 A1
(43) Pub. Date: May 10, 2012

(54) FULL-COLOR REFLECTIVE DISPLAY

(76) Inventors: Stephen Kitson, Bristol (GB); Adrian Geisow, Portishead (GB); Andrew Hunter, Bristol (GB)

(21) Appl. No.: 13/379,775

(22) PCT Filed: Jun. 30, 2009
(86) PCT No.: PCT/US09/49267

§ 371 Date: Dec. 21, 2011

(51) Int. Cl. G02F 1/1335; H01J 9/24

(52) U.S. Cl. 349/106; 445/24

(57) ABSTRACT

A full-color reflective display pixel includes first and second independently addressable electro-optic layers, each layer being independently switchable between a first state in which the layer is configured to absorb at least one color region of visible light and a second state in which the layer is configured to transmit the at least one color region of visible light. A reflective color filter is located between the back surface of the first electro-optic layer and the front surface of the second electro-optic layer, the reflective color filter being subdivided into a plurality of sub-pixels in which each sub-pixel is configured to transmit a first color region of visible light and reflect a second color region of visible light. A broadband reflective layer is located behind the back surface of the second electro-optic layer.

### BACKGROUND

A reflective display is a non-emissive device in which ambient light for viewing the displayed information is reflected from the display back to the viewer rather than light from behind the display being transmitted through the display. Reflective displays use only ambient light as a light source and therefore consume very little energy as compared to backlit or emissive LC (liquid crystal) displays. Reflective display technology is appropriate for outdoor applications where emissive displays cannot produce sufficient brightness or contrast.

Because reflective displays do not have their own light source, is light must pass twice through a number of layers to reach a viewer, and light-absorption by those layers reduces image quality. Therefore, the inherent optical structure of a reflective display provides a major challenge in developing a display capable of producing bright, high-quality images.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A and 1B are cross-sectional diagram of an exemplary liquid crystal reflective display, according to principles described herein.

FIG. 1C is another cross-sectional diagram of an exemplary liquid crystal reflective display, according to principles described herein.

FIG. 2A is a cross-sectional diagram of an exemplary liquid crystal reflective display, according to principles described herein.

FIG. 2B is an illustration of the light reflecting effects of the FIG. 2A liquid crystal display, according to principles described herein.

FIGS. 3A-3D illustrate various electro-optic layer configurations of the FIG. 2A liquid crystal display, according to principles described herein.

FIG. 4 is a diagram of a Cole-Kashnow configuration, according to principles described herein.

FIG. 5 is an illustration of the light reflecting effects of an exemplary liquid crystal reflective display, according to principles described herein.

FIG. 6 is a listing of the various light reflecting effects of an exemplary liquid crystal reflective display, according to principles described herein.

FIG. 7 is a cross-sectional diagram of an exemplary liquid crystal reflective display, according to principles described herein.

FIG. 8 is a table listing various light reflecting effects of an exemplary liquid crystal reflective display, according to principles described herein.

FIG. 9 is a flowchart diagram of an illustrative method of fabricating a full-color reflective display pixel, according to principles described herein.

Throughout the drawings, identical reference numbers designate similar, but not necessarily identical, elements.

### DETAILED DESCRIPTION

This present specification describes systems and methods that increase image quality and brightness through more efficient color use in reflective display technology. In the disclosed system, an optical stack comprises an array of reflective color filters disposed between two electro-optic layers. Because the filters are reflective rather than absorptive, the filters absorb less light, thus increasing display efficiency for brighter, higher-quality images.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

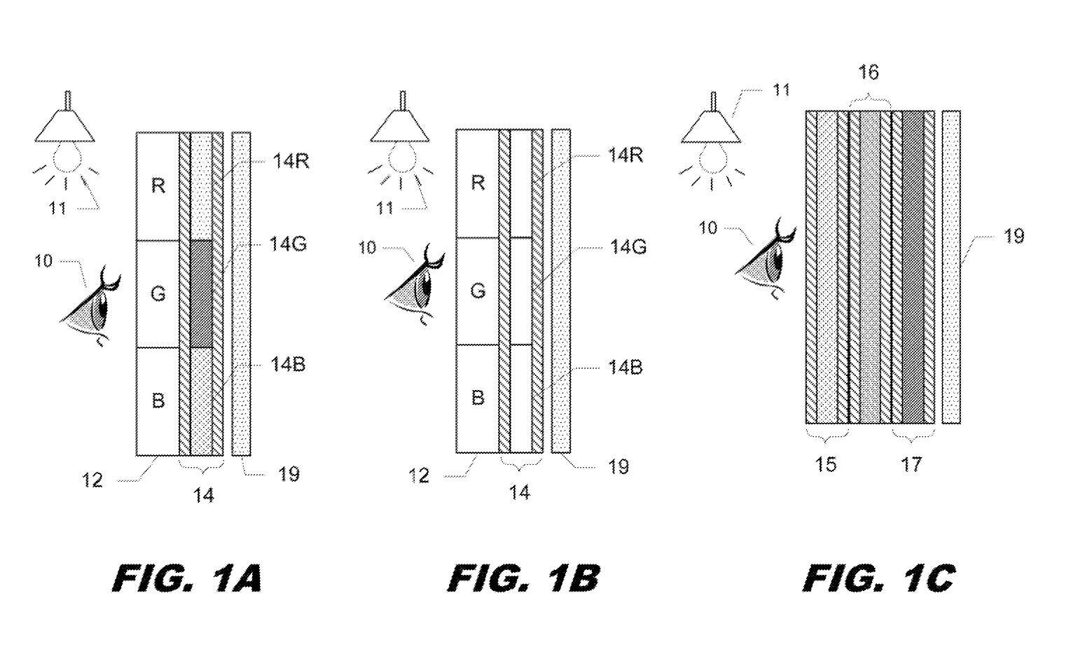

One type of LC display divides each pixel into three sub-pixels. Each sub-pixel includes a red, green, or blue absorptive color filter so as to independently modulate the amount of red, green, and blue light. FIG. 1 is illustrates a conventional LC display. An external light source 11 emits light through each of the red, green and blue filters 12, through the LC optical stack 14, before reflecting off a reflecting surface 19, back through the LC optical stack 14, and filters 12, to a viewer 10. As light passes through each pixel, the red, green or blue filters 12, combined with the LC optical stack 14, absorb the requisite light to produce the desired image. The LC optical stack modulates independently through monochrome sub-pixels 14R, 14G, and 14B, the amount of light reflecting back through each of the red, green or blue filters 12. As shown in FIG. 1B, because each absorptive filter 12 filters red, green, or blue light, even if all the monochrome sub-pixels 14R, 14G, and 14B, are in an “on” state to produce a “white” reflection, the display will absorb at least two-thirds of the ambient light. Additionally, most LC displays include polarizers that absorb approximately 50% of the incident light. By comparison, white paper typically has a reflectivity of around 80%. This system described above can provide improved contrast, but at the expense of light-reflection efficiency.

Another reflective display, illustrated in FIG. 1C, improves reflection efficiency by stacking three displays 15, 16, and 17, on top of each other and arranging the displays such that each layer absorbs one color and transmits the others. The displays typically comprise alternate layers of semi-transparent electrodes with yellow, magenta, and cyan colors. In a three-layer stacked system, external light passes through twelve electrode layers before reaching a viewer 10. If each layer absorbs only 4.5% of the external light source, the best reflectivity will be (0.955)^{Λ}12, or 58% efficient. If other losses are included, the reflective efficiency may be an improvement over conventional displays, but still may not be sufficient in many applications, especially when compared to paper. In addition, the manufacturing complexity of a three-layer display is much higher than a conventional display because there are more layers, and each has to be addressed and aligned with all other layers.

Another reflective display, primarily used in e-book applications, is E-ink (available from E-Ink Corp., Cambridge, Mass.). E-ink reflective displays are inherently monochrome so color E-ink reflective displays include the three side-by-side absorbing color filters in an array on the front of the display. However, similar to the LCD reflective display described above, if a color filter is added to an E-ink display, the filters significantly reduce the brightness, reflecting only one-third of the light. To improve over the 33% reflectivity achieved by the three side-by-side filters, designers have proposed using a four-color array filter, including red, green, blue, and white (RGBW). In this design, switching all of the sub-pixels to the bright state provides a maximum reflectivity of 50%, but at the expense of a smaller color gamut.

Additionally, an electrophoretic display works by sweeping colored pigments sideways out of the field of view or behind opaque structures. (See, e.g. Patent WO/2008/065605, incorporated herein by reference in its entirety). In principle it is possible to have more than one pigment in each layer.

If the pigments have opposite charges, it may be possible to separately address them, allowing the use of only two layers to make a full-color display. A disadvantage of this design is that the particles have to be swept long distances out of the field of view. Present particle transition rates result in switching times that may be too slow for some applications. Additionally, controlling the particles may require complex electrode structures. The result reduces the aperture and limits display resolution. There are also difficulties with stabilizing multiple types of particles in a single fluid.

Embodiments of the disclosed system improve the reflective optical stack by providing an array of reflective color filters disposed between two electro-optic layers. Because the filters are reflective rather than absorptive, the filters absorb less light, thus increasing display efficiency for brighter, higher-quality images. Embodiments of the disclosed system provide better reflective performance that exceeds currently available alternatives such as E-ink with RGBW color filters. The performance approaches that of three-layer systems but without the added complexity of an extra electro-optic layer.

Several electro-optic technologies may be applied in the configurations described below.

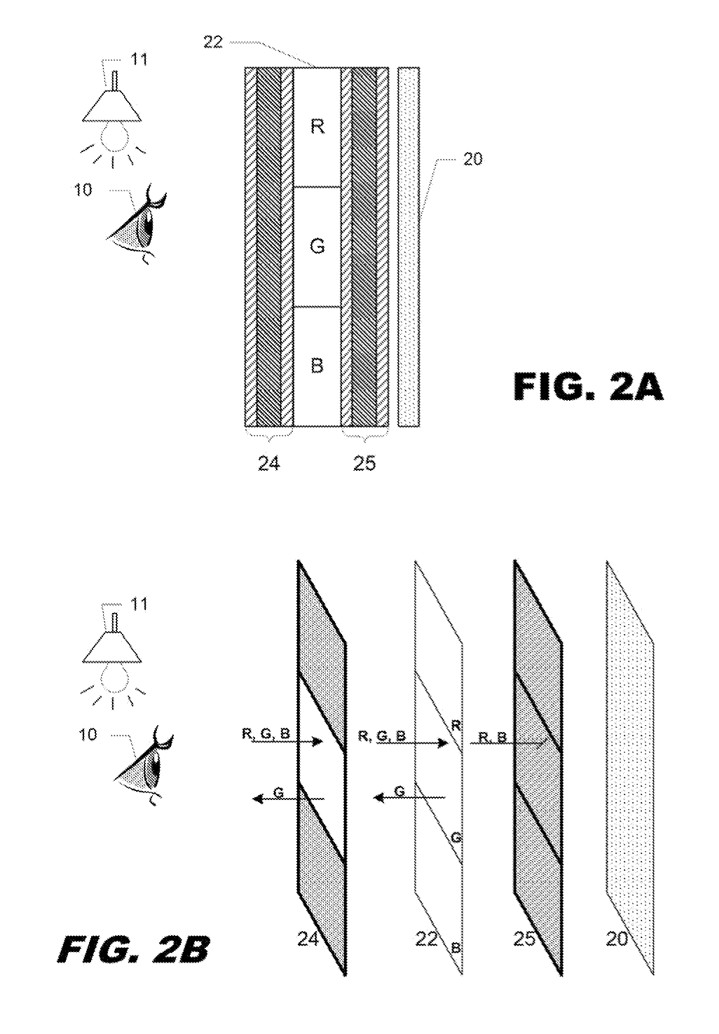

FIG. 2A illustrates an exemplary, non-limiting embodiment of a full-color reflective display. A reflective color filter 22 is disposed between two electro-optic layers 24 and 25. The reflective color filter 22 and the electro-optic layers 24 and 25 are each sub-divided into three sub-pixels. In addition, the sub-pixels in electro-optic layers 24 and 25 are addressable and independently modulated. Electro-optic layers 24 and 25 can be electrically switched between transmission and absorption states. For example, when a sub-pixel of electro-optic layer 24 or 25 is switched to a “black” state, the sub-pixel substantially absorbs all wavelengths of visible light. In contrast, when a sub-pixel of electro-optic layer 24 or 25 is switched to a “clear” state, the sub-pixel substantially transmits all wavelengths of visible light. Other alternative switching states include switching between a colored state, where the sub-pixel substantially absorbs one or more color regions of visible light and transmits or reflects other color regions of visible light, and a clear state, where the sub-pixel substantially transmits or reflects white light. A “color region” as used herein denotes one or more regions of light, for example, red, green, or blue color regions, comprising the wavelengths of light included within the color region. A further alternative includes electro-optic layer 25 switching between a clear state and a reflecting state, in which the clear state transmits white light and the reflecting state reflects white light. In this last embodiment, broadband reflector 20 may instead be a broadband absorber (not shown).

Returning to FIG. 2A, ambient white light comprising red, green, and blue light components (not shown), from a light source 11, transmits first through electro-optic layer 24. Electro-optic layer 24 may transmit or block the ambient light from passing on to red, green or blue regions of the reflective color filter 22. Each sub-pixel of reflective color filter 22 transmits or reflects corresponding light components of red, green, or blue. In contrast to conventional green color filters that absorb the blue and red light and transmit the green light, the “green” sub-pixel of reflective color filter 22 reflects green light and transmits red and blue light. Electro-optic layer 25 then transmits or blocks light transmitted through reflective color filter 22. If switched to clear, electro-optic layer 25 transmits light to broadband reflector 20. Light reflected from broadband reflector 20 proceeds back through electro-optic layer 25, reflective color filter 22, and electro-optic layer 24, to a viewer 10.

The full-color reflective display increases reflection efficiency because reflective color filter 22 does not absorb light. A typical reflective color filter comprises a multilayer stack of alternating dielectrics, with each dielectric having a different refractive index. Alternatively, the reflective color filter may be a cholesteric polymer, such as the reactive mesogen materials available from

Merck Chemicals Ltd. Additionally, the reflective color filter may be a holographic color reflector. Further, the reflective color filter may be an optic layer containing metallic particles that scatter particular colors as a result of localized plasmonic resonances. In practice, the reflection needs to be diffused to give a wider viewing angle. Wider viewing angles may be achieved by roughening the multilayer coating or by the inclusion of a separate diffuser layer. Therefore, the reflective color filter 22 may comprise a roughened surface or include a separate diffuser layer (not shown).

Compared with a system of three or more layers, a two-layer, full-color reflective display may simplify the addressing scheme. The pixels may be addressed through known means. For example, the pixels may be addressed through an active matrix or a passive matrix enabled by an appropriate electro-optical effect with a switching threshold, which may also be bistable. A single thin-film transistor (TFT) array (not shown) could be used to address the electro-optic layers, as taught in U.S. Pat. No. 5,625,474 or U.S. Pat. No. 5,796,447 (both incorporated herein by reference in their entirety), for example, and could be concealed behind the rear broadband reflector 20.

Alternatively, each layer could be addressed by a separate TFT array, with the array for the bottom electro-optic layer hidden behind the broadband reflector 20, and the array for the top layer hidden behind the reflective color filter 22.

FIG. 2B illustrates a more specific embodiment of the full-color reflective display. The red and blue sub-pixels of electro-optic layer 24 are black and the green sub-pixel is clear. Ambient white light comprising red, green, and blue light components (not shown), from a light source 11, transmits first through the “green” (or clear) sub-pixel of electro-optic layer 24. Electro-optic layer 24 absorbs the white light covering the red and blue sub-pixels. The reflective color filter 22 reflects green light back through electro-optic layer 24 and transmits red and blue light onto electro-optic layer 25, where the red and blue light is absorbed. Because reflective color filter 22 reflects only green light, the reflective display illustrated in FIG. 2B produces a strong green reflected color.

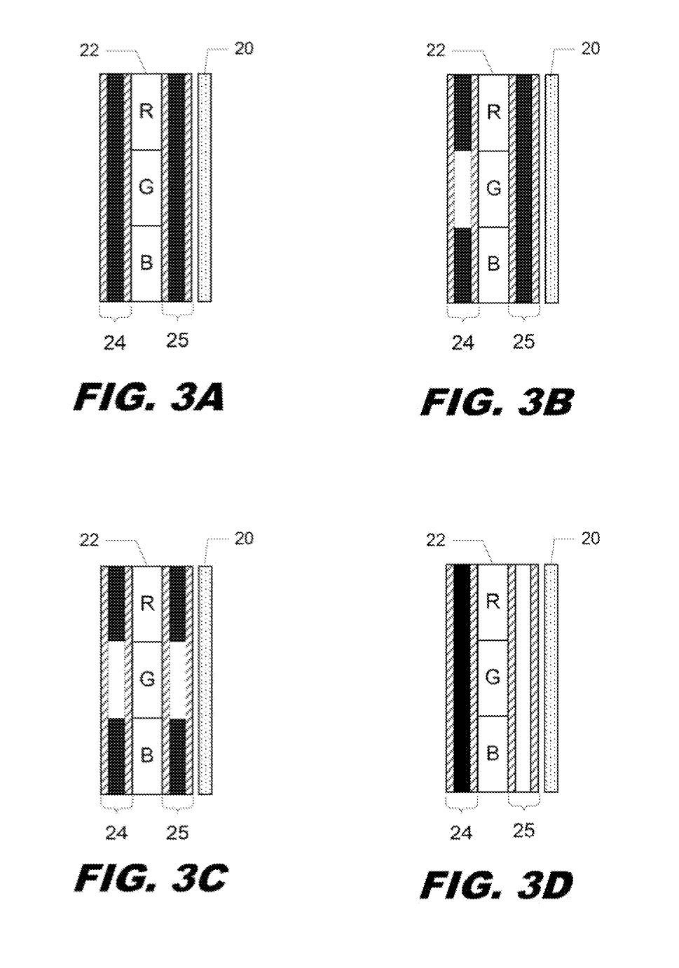

FIGS. 3A, 3B, and 3C illustrate further examples of various electro-optic switching configurations. In FIG. 3A, switching both electro-optic layers 24 and 25 black absorbs all the light, giving black. FIG. 3B′s electro-optic switching configuration produces the same result as FIG. 2B. In FIG. 3C, electro-optic layers 24 and 25 are switched clear in the green region and black in the red and blue regions. FIG. 3C produces a bright white as reflective color filter 22 reflects the blue and red light reflected by the broadband reflector 20. A similar analysis performed for the blue and red sub-pixels demonstrates that this architecture gives a highly reflective white. The shade of white reflected by each sub-pixel will be shifted slightly towards the color of the filter, as the light reflected from the filter passes through fewer layers resulting in less absorption. However, combining the light from the three sub-pixels give a balanced neutral white. The exact brightness will depend on the electrodes used and the type of electro-optic layer, but will exceed the 33% achieved by the LC reflective display illustrated in FIG. 1A, the three-layer reflective display illustrated in FIG. 1C, or the reflectivity of an E-ink display with RGBW filters.

FIG. 3D illustrates a fourth electro-optic switching combination. Electro-optic layers 24 and 25 are black and clear, respectively.

The reflected color in this configuration depends on the electro-optic configuration. If the electro-optic configuration absorbs both polarizations (S & P) of the incident light, the display will appear black. However, a common electro-optic configuration absorbs only one polarization. The liquid crystal layer uses liquid crystal doped with dichroic dyes and switches the liquid crystal between a vertical alignment (non-absorbing) and a horizontal alignment (absorbing). The liquid crystal layer absorbs only the P or S-polarization depending on the orientation of the light's plane of incidence with respect to the liquid crystal alignment. To achieve a higher-contrast image, both polarizations must be absorbed.

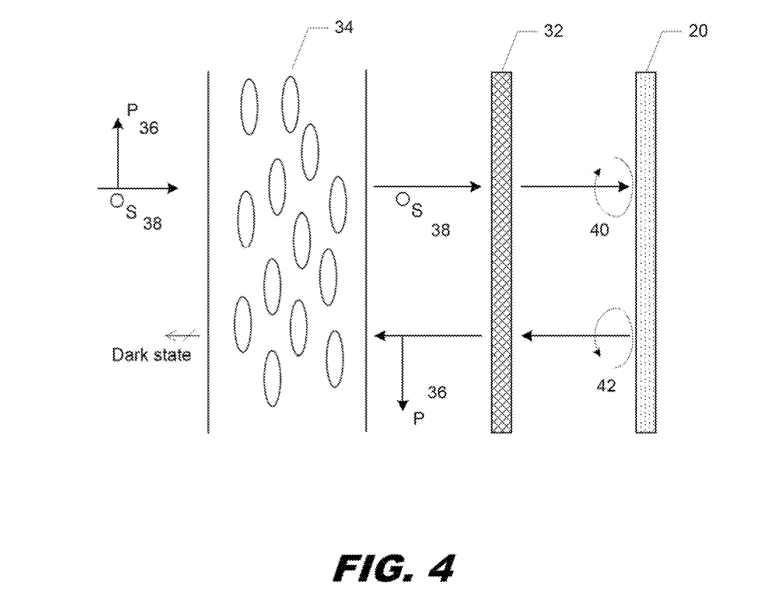

FIG. 4 illustrates an electro-optic configuration that absorbs both polarizations. A dichroic liquid crystal layer 34, aligned horizontally, absorbs only the parallel, or P-polarization of light 36. S-polarized light 38 emerges from the dichroic liquid-crystal layer 34 and passes through a quarter-wave plate 32, which is oriented forty-five degrees to the liquid-crystal alignment. The quarter-wave plate 32 is disposed between the dichroic liquid-crystal layer 32 and a broadband reflector 20. The wave plate 32 converts the S-polarization 38 to circular polarization 40 and the reflection from the broadband reflector 20 causes a phase change 42. The light reemerges from the wave plate 32 as linear, P-polarized light 36, which is then absorbed on the second pass by the dichroic liquid crystal layer 34. This is known as the Cole-Kashnow configuration.

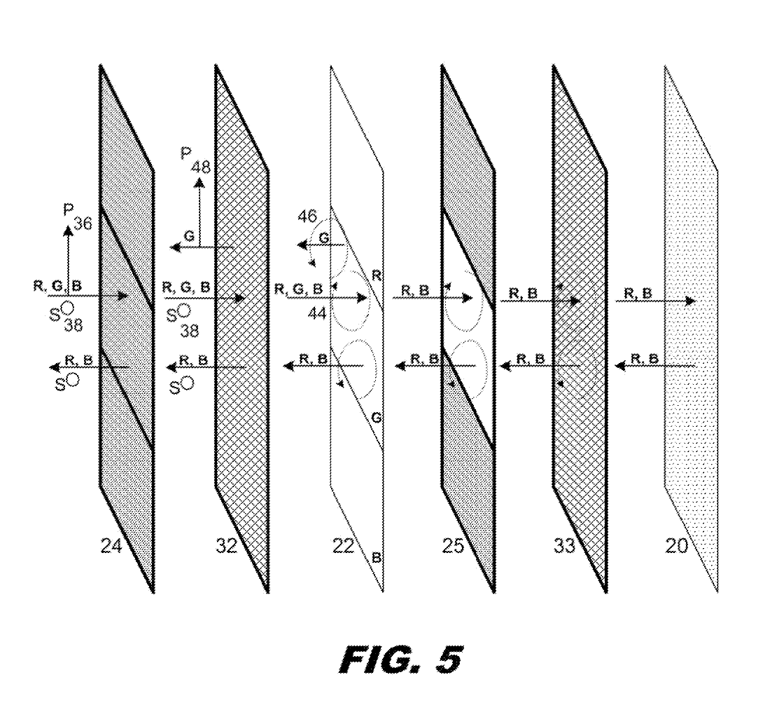

FIG. 5 illustrates a Cole-Kashnow configuration in a two-layer device with side-by-side reflective color filters 22. To better explain the electro-optic effect, the following descriptions focus again on the green sub-pixel.

However, a similar evaluation may be performed with either the red or blue sub-pixels. Electro-optic layer 24 receives white, unpolarized light, or light that includes both P 36 and S-polarized light 38. By way of illustration, electro-optic layer 24, in its dark state, absorbs the P-polarization light 36, but either the P 36 or S-polarization 38 may be absorbed depending on the orientation of the liquid crystals. S-polarized light 38 emerging from electro-optic layer 24 is linearly polarized. A quarter wave plate 32 circularly polarizes all three colors (red, green, and blue). A reflective color filter 22 reflects and changes the phase of the green portion of the light 46. The green portion of the light then becomes linearly polarized 48 (P-polarized) on its return pass through the quarter wave plate 32 and is then absorbed by electro-optic layer 24. The blue and red circularly polarized light pass through reflective color filter 22 and electro-optic layer 25, which is in its clear state in the portion covering the green sub-pixel. The blue and red light then pass through a second wave plate 33 before being reflected back through the layers eventually reaching electro-optic layer 24 again. The extra passes through the second wave-plate 33 rotate the polarization so that when the light reaches the top electro-optic layer it is now linearly polarized but is now oriented in the direction orthogonal to the liquid crystal alignment.

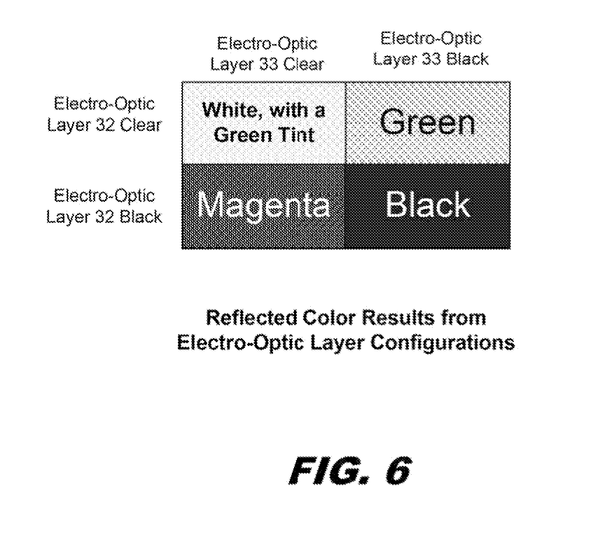

FIG. 6 shows the results of modeling the optics of the FIG. 5 configuration in the four possible combinations of electro-optic layers 32 and 33. Switching electro-optic layer 32 black and electro-optic layer 33 clear gives a dark version of the color that is complementary to the filter. Modeling the other sub-pixels gives equivalent results. We can use this to boost the brightness of the displayed magenta, cyan or yellow. Modeling shows that this increases the volume of the color gamut by approximately 20%.

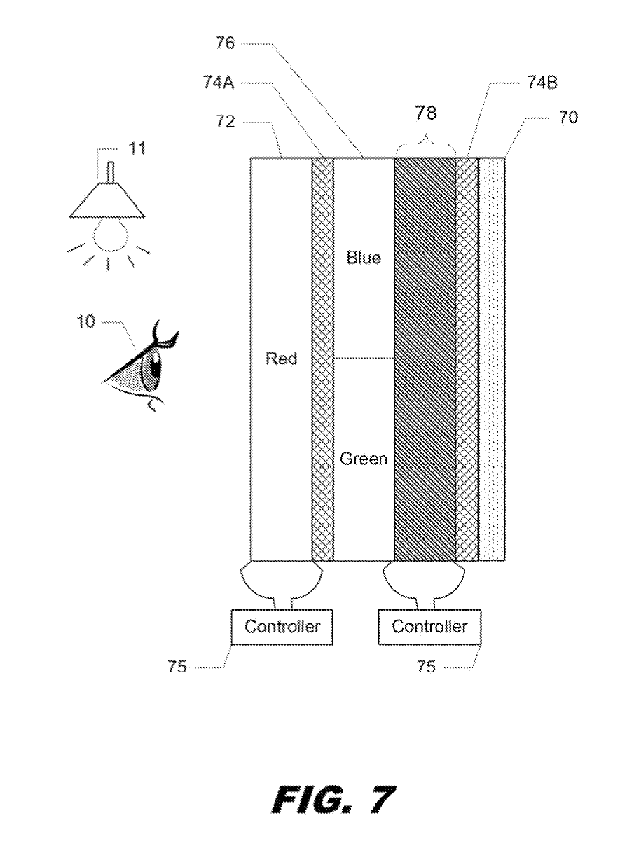

In a further embodiment of the full-color reflective display, each pixel is split into only two side-by-side color sub-pixels. FIG. 7 illustrates an example with blue and green reflecting filters 76. In this configuration, the electro-optic layer 78 switches between black and clear and electro-optic layer 72 switches between red (green and blue absorbing) and clear. Alternatively, electro-optic layer 72 could switch between blue and clear or green and clear, with red and green or blue and red reflecting filters, respectively. A controller 75 controls the transmissive/absorptive states of electro-optic layers 78 and 72.

As mentioned previously, a further embodiment may include electro-optic layer 78 switching between a clear state and a reflective state, in which the clear state transmits white light and the reflecting state reflects white light. In this last embodiment, broadband reflector 70 may instead be a broadband absorber (not shown).

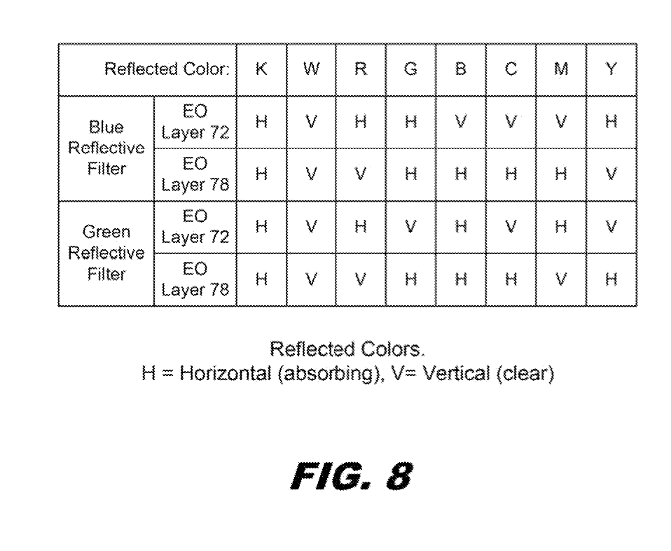

The two sub-pixel configuration includes two quarter-wave plates 74A and 74B: one disposed between the red/clear dichroic layer 72 and the blue/green electro-optic reflecting filter 76, the other disposed between the black/clear dichroic layer 78 and a broadband reflector 70. FIG. 8 lists the reflected color result for each combination of electro-optic layer configurations.

One primary advantage of the two sub-pixel configuration is that each reflective color filter covers one-half instead of one-third of a pixel, increasing the reflected brightness of the colors and increasing the volume of the color gamut by approximately 50%. Depending on the electrode technology used, reducing the number of sub-pixels may also reduce the optical loss in the electrode layers.

In the two sub-pixel, Cole-Kashnow configuration, the effects of extra passes through the wave plates 74A and 74B must again be considered when using a dichroic electro-optic layer. Modeling indicates the effect is a shift in the color points. In the version shown in FIG. 7, the yellow and magenta color points shift towards the green and blue hues, respectively. The two sub-pixel configuration produces a different color gamut shape than the three sub-pixel color gamut shape, but does still encompass most of the colors that can be rendered with the three sub-pixel configuration.

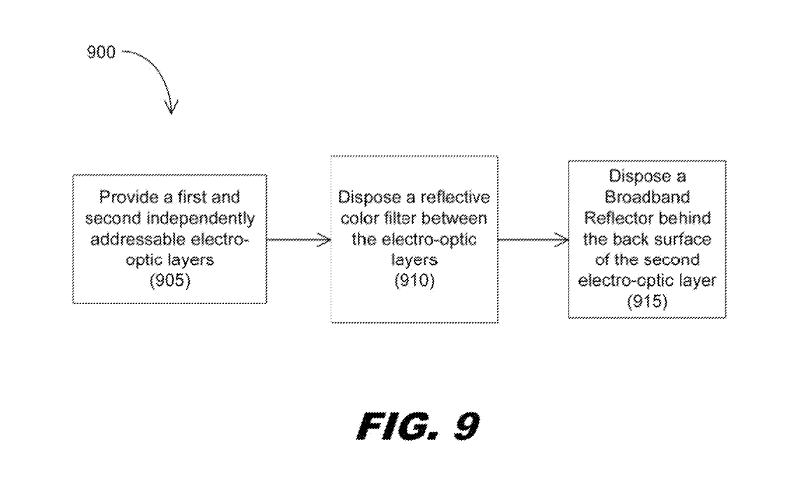

FIG. 9 shows a flowchart of an illustrative embodiment of a method (900) of fabricating a full-color reflective display pixel. The method (900) includes providing (step 905) first and second independently addressable electro-optic layers. Each of the layers may have a front and back surface and be independently switchable between a first state, in which the layer is configured to absorb one or more color regions of visible light, and a second state, in which the layer is configured to transmit the least one color region of light.

A reflective color filter subdivided into a plurality of sub-pixels is then disposed (step 910) between the back surface of the first electro-optic layer and the front surface of the second electro-optic layer. Each sub-pixel may be configured to transmit a first color region of visible light and reflect a second color region of visible light. For example, in certain embodiments one sub-pixel may be configured to reflect only red light, a second sub-pixel may be configured to reflect only green light, and a third sub-pixel may be configured to reflect only blue light. The electro-optic layers may be partitioned into independently switchable segments corresponding to the sub-pixels such that each sub-pixel may be manipulated to either allow or prevent ambient light from being reflected by each of the sub-pixels to achieve a desired display shade.

Additionally, the method further includes (step 915) disposing a broadband reflective layer behind the back surface of the second electro-optic layer

The preceding description has been presented only to illustrate and describe embodiments and examples of the principles described. This description is not intended to be exhaustive or to limit these principles to any precise form disclosed. Many modifications and variations are possible in light of the above teaching.

1. A full-color reflective display pixel, comprising:
first and second independently addressable electro-optic layers, such that each layer comprises a front and back surface and is independently switchable between a first state in which the layer is configured to absorb at least one color region of visible light and a second state in which the layer is configured to transmit said at least one color region of visible light;
a reflective color filter disposed between the back surface of the first electro-optic layer and the front surface of the second electro-optic layer, said reflective color filter being subdivided into a plurality of sub-pixels in which each sub-pixel is configured to transmit a first color region of visible light and reflect a second color region of visible light; and
a broadband reflective layer disposed behind the back surface of the second electro-optic layer.

2. The full-color reflective display pixel according to claim 1, in which the reflective color filter comprises a first and second dielectric layer, in which:
the first and second dielectric layers are stacked adjacent each other; and
the first and second dielectric layers having different refractive indices

3. The full-color reflective display pixel according to claim 1, in which the reflective color filter comprises a roughened surface.

4. The full-color reflective display pixel according to claim 1, in which the reflective color filter further comprises a separate diffuser layer.

5. The full-color reflective display pixel according to claim 1, in which the first state of the second electro-optic layer transmits white light and the second state of the second electro-optic layer reflects white light.

6. The full-color reflective display pixel according to claim 1, further comprising at least one transistor.

7. The full-color reflective display pixel according to claim 1, in which the first and second electro-optic layers are passively matrixable.

8. The full-color reflective display pixel according to claim 1, in which the electro-optic layers are partitioned into independently switchable segments corresponding to the sub-pixels of the reflective display pixel.

9. The full-color reflective display pixel according to claim 1, further comprising:
a first quarter-wave plate disposed between the back surface of the first electro-optic layer and the reflective color filter; and
a second quarter-wave plate disposed between the back surface of the second electro-optic layer and the broadband reflector.

10. The full-color reflective display pixel according to claim 1, in which each of the first and second electro-optic layers comprises one of:
a color dichroic layer and a black dichroic layer.

11. The full-color reflective display pixel according to claim 1, in which:
the first electro-optic layer is configured to absorb a plurality of color regions of visible light while in the first state and substantially transmit all wavelengths of visible light while in the second state, and
the second electro-optic layer is configured to absorb substantially all wavelengths of visible light while in the first state and transmit substantially all wavelengths of visible light while in the second state.

12. A full-color reflective display, comprising:
a plurality of independently addressable pixels, each of said pixels comprising:
first and second independently addressable electro-optic layers, in which each layer comprises a front and back surface and is independently switchable between a first state, in which the layer is configured to absorb a plurality of color regions of visible light, and a second state, in which the layer is configured to substantially transmit all wavelengths of visible light;
a reflective color filter disposed between the back surface of the first electro-optic layer and the front surface of the second electro-optic layer, said reflective color filter being subdivided into a plurality of sub-pixels in which each sub-pixel is configured to transmit a first color region of visible light and reflect a second color region of visible light; and
a broadband reflective layer disposed behind the back surface of the second electro-optic layer, the broadband reflector including a front and back surface; and
a controller configured to selectively switch said electro-optic layers of said pixels to produce a desired image on said display.

13. The full-color reflective display according to claim 12, in which the second electro-optic layer of each pixel is subdivided into one of:
two color sub-pixels and three color sub-pixels.

14. A method of fabricating a full-color display pixel, comprising:
providing first and second electro-optic layers, each layer comprising a front and back surface and being independently switchable between a first state in which the layer is configured to absorb at least one region of visible light and a second state in which the layer is configured to transmit at least one color region of visible light;
disposing a reflective color filter between the back surface of the first electro-optic layer and the front surface of the second electro-optic layer, said reflective color filter being subdivided into a plurality of sub-pixels, in which each sub-pixel is configured to transmit a first color region of visible light and reflect a second color region of visible light; and
disposing a broadband reflective layer behind the back surface of the second electro-optic layer.

15. The method of claim 14, in which the second electro-optic layer of each pixel is subdivided into one of:
two color sub-pixels and three color sub-pixels.
